(19) United States
(12) Patent Application Publication
(10) Pub. No.: US 2018/0048336 A1
(43) Pub. Date: Feb. 15, 2018

(54) DIVERSITY SWITCH CIRCUIT, RADIO-FREQUENCY MODULE, AND COMMUNICATION DEVICE

(71) Applicant: Murata Manufacturing Co., Ltd., Nagaokakyo-shi (JP)

(72) Inventor: Teruaki OSHITA, Nagaokakyo-shi (JP)

(21) Appl. No.: 15/672,363

(22) Filed: Aug. 9, 2017

(30) Foreign Application Priority Data
Aug. 10, 2016 (JP) 2016-158048
May 25, 2017 (JP) 2017-103471

(51) Int. Cl. H04B 1/00; H04B 1/16; H04B 7/0404; H04B 1/44; H04B 7/08; H04B 7/06

(52) U.S. Cl. CPC H04B 1/006; H04B 7/0825; H04B 7/0602; H04B 7/0404; H04B 1/0064; H04B 1/44; H04B 1/1615

(57) ABSTRACT

A diversity switch circuit includes first and second switches. The first switch includes a first common terminal connected to a diversity antenna, a first selection terminal connected to a first signal path, and a second selection terminal connected to a second signal path. The second signal path is a path different from the first signal path. The second switch is disposed in the first signal path and includes a second common terminal connected to the first selection terminal and at least two selection terminals. A received signal received by the diversity antenna is transmitted to the first signal path when the first common terminal and the first selection terminal are connected to each other. A sending signal to be sent by the diversity antenna is transmitted to the second signal path when the first common terminal and the second selection terminal are connected to each other.

### CROSS REFERENCE TO RELATED APPLICATIONS

This application claims the benefit of priority to Japanese Patent Application No. 2017-103471 filed on May 25, 2017 and Japanese Patent Application No. 2016-158048 filed on Aug. 10, 2016. The entire contents of this application are hereby incorporated herein by reference.

### BACKGROUND OF THE INVENTION

### 1. Field of the Invention

The present invention relates to a diversity switch circuit, a radio-frequency module, and a communication device.

### 2. Description of the Related Art

Hitherto, a sub antenna, which is called a diversity antenna, provided separately from a main antenna, has been used with the main antenna to improve the quality and the reliability of communication for receiving signals. Lately, there has been an increasing demand for multiband- and multimode-support communication devices, such as cellular phones, in which a single terminal handles multiple frequency bands and multiple wireless systems. To satisfy such a demand, a diversity switch circuit is used for separating signals received by a diversity antenna according to the frequency band. More specifically, Japanese Unexamined Patent Application Publication No. 2015-517753 discloses a diversity switch circuit such as that shown in FIG. 7. FIG. 7 is a schematic diagram illustrating an example of a known diversity switch circuit 400.

As shown in FIG. 7, in the diversity switch circuit 400, a switch 410 connected to a diversity antenna ANT and a multiband-support switch circuit 420 are connected in series with each other. The switch circuit 420 includes switches 423a, 423b, . . . , and 423n as n switches connected to signal paths through which multiple signals of different frequency bands are transmitted. Circuits, such as filters that filters received signals or low-noise amplifiers (LNAs) for amplifying received signals, are connected to the switches 423a, 423b, . . . , and 423n, though they are not shown in FIG. 7. The diversity switch circuit 400 may receive a high power signal for some reasons, for example, due to a short distance between a base station and a communication device having the diversity switch circuit 400 mounted thereon. In this case, the switch 410 and the switch circuit 420 may be broken or the performance may be decreased. To avoid such a situation, when the diversity antenna ANT receives a high power signal, the switch 410 is turned OFF so that the switch 410 and the switch circuit 420 will not receive such a signal.

Although a diversity antenna is typically used as a receive antenna, it may be expected to be used also as a transmit antenna in accordance with an increase in the multiband-support terminals and the communication traffic. However, the diversity switch circuit disclosed in the above-described publication is a receive-only circuit for receiving multiband signals, and is unable to handle sending signals. A transmit diversity antenna is thus required to be separate from the receive diversity antenna. This increases the number of antennas required in a communication device, such as a cellular phone. A larger antenna space is accordingly required in a housing of the communication device, thus making it difficult to reduce the size of the communication device.

### SUMMARY OF THE INVENTION

Accordingly, preferred embodiments of the present invention provide diversity switch circuits, radio-frequency modules, and communication devices that are able to use a diversity antenna as a transmit-and-receive antenna.

According to a preferred embodiment of the present invention, a diversity switch circuit includes first and second switches. The first switch includes a first common terminal connected to a diversity antenna, a first selection terminal connected to a first signal path, and a second selection terminal connected to a second signal path. The second signal path is a path different from the first signal path. The second switch is disposed in the first signal path and includes a second common terminal connected to the first selection terminal and includes at least two selection terminals. A received signal received by the diversity antenna is transmitted to the first signal path when the first common terminal and the first selection terminal are connected to each other. A sending signal to be sent by the diversity antenna is transmitted to the second signal path when the first common terminal and the second selection terminal are connected to each other.

When the first common terminal and the first selection terminal are connected to each other, the single diversity antenna is able to be used as a receive antenna. By connecting the second common terminal and a specific one of the at least two selection terminals to each other in the second switch, the diversity antenna receives a desired signal. The specific selection terminal is a selection terminal to which a filter (elastic wave filter, for example) having the pass band corresponding to the frequency band of the desired signal is connected. When the first common terminal and the second selection terminal are connected to each other, a sending signal transmitted to the second signal path is sent to the single diversity antenna. Thus, the single diversity antenna is also able to be used as a transmit antenna. By using the diversity switch circuit that is able to receive signals of different frequency bands, the diversity antenna may be used as a transmit-and-receive antenna. It is thus possible to reduce the size of a communication device, such as a cellular phone.

A terminating resistor may be connected to one of the at least two selection terminals of the second switch.

The diversity antenna is preferably used as a transmit-and-receive antenna. For this reason, even when the first common terminal and the first selection terminal are not connected to each other, a high-power sending signal transmitted to the second signal path may leak to the second switch. Additionally, even when the first common terminal and the first selection terminal are not connected to each other, a high power signal received by the diversity antenna may leak to the second switch. To address this issue, a terminating resistor is connected to one of the at least two selection terminals of the second switch. When the diversity antenna is used as a transmit antenna or when the diversity antenna receives a high power signal, by connecting the second common terminal and the selection terminal to which the terminating resistor is connected, the terminating resistor is able to output energy of a high power signal to a ground. It is thus less likely that a circuit, such as a filter or an LNA, connected to the second switch will be broken or the performance will be decreased by a high power signal.

A matching circuit may be connected between the first selection terminal and the second common terminal.

The matching circuit performs impedance matching between the first and second switches, thus decreasing the level of loss (return loss) which may occur in a signal transmitted to the first signal path.

The second switch may include two or more second switches. A first multiplexer may be connected between the first selection terminal and the second common terminal of each of the two or more second switches.

It is thus possible to simultaneously receive multiple signals of different frequency bands, such as a low band (LB), a middle band (MB), and a high band (HB), received by the diversity antenna, thus achieving CA communication.

The first switch may also include a third selection terminal connected to the first signal path. A third switch may be connected between the first multiplexer and the second common terminal. A received signal received by the diversity antenna may be transmitted to the first signal path without passing through the first multiplexer when the first common terminal and the third selection terminal are connected to each other and when the third switch is OFF.

By connecting the first common terminal and the third selection terminal to each other and by turning OFF the third switch, a received signal received by the diversity antenna is able to be transmitted to the first signal path without passing through the first multiplexer. When CA communication is performed, the first common terminal and the first selection terminal are connected to each other and the third switch is turned ON. When CA communication is not performed, the first common terminal and the third selection terminal are connected to each other and the third switch is turned OFF. It is thus possible to reduce loss (insertion loss) which may occur in a received signal by the first multiplexer when CA communication is not performed.

The diversity switch circuit may further include a fourth switch. The fourth switch is disposed in the second signal path and includes a third common terminal connected to the second selection terminal and includes at least two selection terminals.

The fourth switch enables the diversity switch circuit to simultaneously send multiple sending signals of different frequency bands.

A matching circuit may be connected between the second selection terminal and the third common terminal.

The matching circuit performs impedance matching between the first and fourth switches, thus decreasing the level of loss (return loss) which may occur in a signal transmitted to the second signal path.

The fourth switch may include two or more fourth switches. A second multiplexer may be connected between the second selection terminal and the third common terminal of each of the two or more fourth switches.

It is thus possible to simultaneously send multiple signals of different frequency bands, such as the LB, MB, and HB, thus achieving CA communication.

The first switch may also include a fourth selection terminal connected to the second signal path. A fifth switch may be connected between the second multiplexer and the third common terminal. A sending signal to be sent by the diversity antenna may be transmitted to the second signal path without passing through the second multiplexer when the first common terminal and the fourth selection terminal are connected to each other and when the fifth switch is OFF.

By connecting the first common terminal and the fourth selection terminal to each other and by turning OFF the fifth switch, a signal transmitted to the second signal path is able to be sent to the diversity antenna without passing through the second multiplexer. When CA communication is performed, the first common terminal and the second selection terminal are connected to each other and the fifth switch is turned ON. When CA communication is not performed, the first common terminal and the fourth selection terminal are connected to each other and the fifth switch is turned OFF. It is thus possible to reduce loss (insertion loss) which may occur in a sending signal by the second multiplexer when CA communication is not performed.

According to a preferred embodiment of the present invention, a radio-frequency module includes the above-described diversity switch circuit, a filter, and an amplifier circuit. The filter is connected to the at least two selection terminals of the second switch or to the at least two selection terminals of the fourth switch. The amplifier circuit is connected to the filter.

It is thus possible to provide a radio-frequency module that is able to use a diversity antenna as a transmit-and-receive antenna.

According to a preferred embodiment of the present invention, a communication device includes a radio-frequency signal processing circuit that processes the above-described received signal and sending signal and the above-described radio-frequency module. The radio-frequency module sends the sending signal and receives the received signal between the diversity antenna and the radio-frequency signal processing circuit.

It is thus possible to provide a communication that is able to use a diversity antenna as a transmit-and-receive antenna.

According to preferred embodiments of the present invention, it is possible to provide diversity switch circuits, radio-frequency modules, and communication devices that are able to use a diversity antenna as a transmit-and-receive antenna.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram illustrating an example of a diversity switch circuit according to a first preferred embodiment of the present invention.

FIG. 2 is a schematic diagram illustrating an example of a diversity switch circuit according to a second preferred embodiment of the present invention.

FIG. 3 is a schematic diagram illustrating an example of a diversity switch circuit according to a third preferred embodiment of the present invention.

FIG. 4 is a schematic diagram illustrating an example of a diversity switch circuit according to a fourth preferred embodiment of the present invention.

FIG. 5 is a schematic diagram illustrating an example of a diversity switch circuit according to a fifth preferred embodiment of the present invention.

FIG. 6 is a schematic diagram illustrating an example of a communication device according to a sixth preferred embodiment of the present invention.

FIG. 7 is a schematic diagram illustrating an example of a known diversity switch circuit.

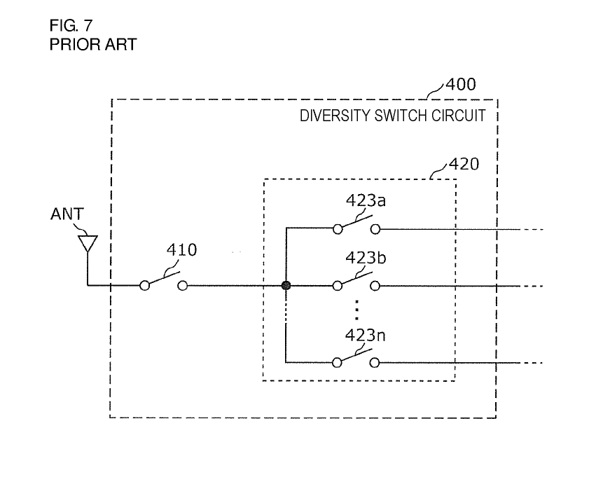

### DETAILED DESCRIPTION OF THE PREFERRED EMBODIMENTS

Preferred embodiments of the present invention will be described below in detail with reference to the accompanying drawings. All of the preferred embodiments described below illustrate general or specific examples. Numerical values, components, and positions and connection states of the components illustrated in the following preferred embodiments are only examples, and do not limit the present invention. Among the components illustrated in the following preferred embodiments, the components that are not recited in the independent claims which embody the broadest concept of the present invention will be described as optional components. The drawings are only schematic drawings and do not necessarily illustrate the components precisely. In the drawings, the same components are designated by like reference numeral.

### First Preferred Embodiment

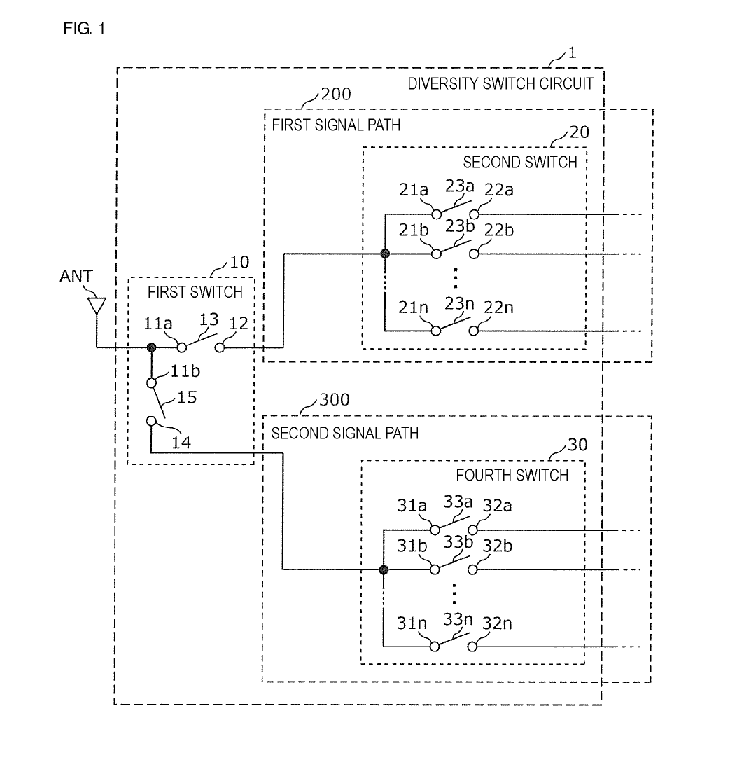

A diversity switch circuit 1 according to a first preferred embodiment of the present invention will be described below with reference to FIG. 1.

FIG. 1 is a schematic diagram illustrating an example of the diversity switch circuit 1 according to the first preferred embodiment.

The diversity switch circuit 1 is a circuit that is able to receive signals of different frequency bands received by a diversity antenna ANT. In the first preferred embodiment, the diversity switch circuit 1 is also able to simultaneously send multiple sending signals of different frequency bands. The diversity antenna ANT is a sub antenna provided separately from a main antenna and is used to improve the quality and the reliability of communication. The diversity antenna is typically used as a receive antenna. In the preferred embodiments of the present invention, however, the diversity antenna is able to be used as a transmit-and-receive antenna.

The diversity switch circuit 1 includes a first switch 10, a second switch 20, and a fourth switch 30.

The first switch 10 includes a first common terminal 11 connected to the diversity antenna ANT. The first switch 10 also includes a first selection terminal 12 connected to a first signal path 200 and a second selection terminal 14 connected to a second signal path 300. The second selection terminal 14 is a path different from the first signal path 200. In the first preferred embodiment, the first switch 10 includes first common terminals 11a and 11b, which are collectively called the first common terminal 11. The first switch 10 includes switches 13 and 15. Turning ON the switch 13 connects the first common terminal 11a and the first selection terminal 12. Turning ON the switch 15 connects the first common terminal 11b and the second selection terminal 14. When the switch 13 is ON, the switch 15 is OFF. When the switch 15 is ON, the switch 13 is OFF. However, both of the switches 13 and 15 may be ON during a certain period.

The switches 13 and 15 are semiconductor switches such as diode switches or field-effect transistor (FET) switches, and are turned ON or OFF in accordance with a control signal from an external source (radio-frequency (RF) signal processing circuit (radio frequency integrated circuit (RFIC)) 120, which will be discussed later, for example) outside the first switch 10. The first common terminals 11a and 11b may be one integrated terminal. In this case, instead of the switches 13 and 15, the first switch includes a switch that changes the connection between the integrated first common terminal 11 and one of the first and second selection terminals 12 and 14. However, the first common terminal may still be able to simultaneously connect to the first selection terminal 12 and to the second selection terminal 14.

The second switch 20 includes a second common terminal 21 connected to the first selection terminal 12 and also includes at least two selection terminals 22. The second common terminal 21 may be directly connected to the first selection terminal 12 or be indirectly connected to the first selection terminal 12 via another circuit (a matching circuit 50 or a multiplexer 60, which will be discussed later, for example). The second switch 20 includes a switch 23. Turning ON the switch 23 connects the second common terminal 21 and the selection terminal 22. In the first preferred embodiment, the second switch 20 includes n second common terminals, that is, second common terminals 21a, 21b, . . . , and 21n, which are collectively called the second common terminal 21. The second switch 20 also includes n selection terminals, that is, selection terminals 22a, 22b, . . . , and 22n, which are collectively called the selection terminal 22. The second switch 20 includes n switches, that is, switches 23a, 23b, . . . , and 23n, which are collectively called the switch 23. Turning ON the switch 23n, for example, connects the second common terminal 21n and the selection terminal 22n.

The switch 23 preferably is a semiconductor switch such as a diode switch or an FET switch, and is turned ON or OFF in accordance with a control signal from an external source (RF signal processing circuit 120, which will be discussed later, for example) outside the second switch 20. The second common terminals 21a, 21b, . . . , and 21n may be one integrated terminal. In this case, instead of the switches 23a, 23b, . . . , and 23n, the second switch includes a switch that changes the connection between the integrated second common terminal 21 and one of the selection terminals 22a, 22b, . . . , and 22n. However, the second common terminal 21 may still be able to simultaneously connect to two or more of the selection terminals 22a, 22b, . . . , and 22n.

The second switch 20 is disposed on the first signal path 200. This means that the second switch 20 is disposed on a path connected to the first selection terminal 12 of the first switch 10. For example, when the second common terminal 21n and the selection terminal 22n are connected to each other, a signal passes through a path connecting the first selection terminal 12, the second common terminal 21n, and the selection terminal 22n as the first signal path 200.

The fourth switch 30 includes a third common terminal 31 connected to the second selection terminal 14 and also includes at least two selection terminals 32. The third common terminal 31 may be directly connected to the second selection terminal 14 or be indirectly connected to the second selection terminal 14 via another circuit. The fourth switch 30 includes a switch 33. Turning ON the switch 33 connects the third common terminal 31 and the selection terminal 32. In the first preferred embodiment, the fourth switch 30 includes n third common terminals, that is, third common terminals 31a, 31b, . . . , and 31n, which are collectively called the third common terminal 31. The fourth switch 30 also includes n selection terminals, that is, selection terminals 32a, 32b, . . . , and 32n, which are collectively called the selection terminal 32. The fourth switch 30 includes n switches, that is, switches 33a, 33b, . . . , and 33n, which are collectively called the switch 33. Turning ON the switch 33n, for example, connects the third common terminal 31n and the selection terminal 32n. The switch 33 is a semiconductor switch such as a diode switch or an FET switch, and is turned ON or OFF in accordance with a control signal from an external source (RF signal processing circuit 120, which will be discussed later, for example) outside the fourth switch 30. The third common terminals 31a, 31b, . . . , and 31n may be one integrated terminal. In this case, instead of the switches 33a, 33b, . . . , and 33n, the fourth switch 30 includes a switch that changes the connection between the integrated third common terminal 31 and one of the selection terminals 32a, 32b, . . . , and 32n. However, the third common terminal 31 may still be able to simultaneously connect to two or more of the selection terminals 32a, 32b, . . . , and 32n.

The fourth switch 30 is disposed on the second signal path 300. This means that the fourth switch 30 is disposed on a path connected to the second selection terminal 14 of the first switch 10. For example, when the third common terminal 31n and the selection terminal 32n are connected to each other, a signal passes through a path connecting the second selection terminal 14, the third common terminal 31n, and the selection terminal 32n as the second signal path 300.

A signal received by the diversity antenna ANT passes through the first signal path 200 when the first common terminal 11a and the first selection terminal 12 are connected to each other. That is, the first signal path 200 is a path that transmits a signal received by the diversity antenna ANT. A receiving filter (filter constituted by an elastic wave resonator or an LC circuit) or an amplifier circuit, such as an LNA, is thus connected to the selection terminal 22 of the second switch 20. Filters having different pass bands from each other are connected to the selection terminals 22a, 22b, . . . , and 22n, so that the diversity switch circuit 1 is able to receive signals of different frequency bands by using the second switch 20.

A signal to be sent from the diversity antenna ANT is transmitted to the second signal path 300 when the first common terminal 11b and the second selection terminal 14 are connected to each other. That is, the second signal path 300 is a path that transmits a sending signal to be sent from the diversity antenna ANT. A sending filter (filter constituted by an elastic wave resonator or an LC circuit) or an amplifier circuit, such as a power amplifier (PA), is thus connected to the selection terminal 32 of the fourth switch 30. Filters having different pass bands from each other are connected to the selection terminals 32a, 32b, . . . , and 32n, so that multiple sending signals of different frequency bands are able to be simultaneously sent via the fourth switch 30. That is, among multiple sending signals of different frequency bands, one or more sending signals selected by the fourth switch 30 can be sent from the diversity antenna ANT. As described above, the first switch 10 includes the second selection terminal 14. When the first common terminal 11b and the second selection terminal 14 are connected to each other, a sending signal transmitted to the second signal path 300 can be sent to the diversity antenna ANT. That is, the diversity antenna ANT is able to be used as a transmit antenna as well as a receive antenna.

As shown in FIG. 1, the first signal path 200 and the second signal path 300 are different paths. The path connecting the first signal path 200 and the diversity antenna ANT and the path connecting the second signal path 300 and the diversity antenna ANT branch off from the diversity antenna ANT at a position closer to the diversity antenna ANT than to the switches 13, and 15. Accordingly, the switch 13 is not disposed on the path connecting the second signal path 300 and the diversity antenna ANT. It is thus less likely that loss caused by the switch 13 will occur in a sending signal transmitted to the second signal path 300. As stated above, the first signal path 200 and the second signal path 300 are different paths. This means that a path connected to the selection terminal 22 (the path of the second switch 20 opposite the path close to the diversity antenna ANT as viewed from the diversity antenna ANT, that is, the path connected to the right side of the second switch 20 in FIG. 1) and a path connected to the selection terminal 32 (the path of the fourth switch 30 opposite the path close to the diversity antenna ANT as viewed from the diversity antenna ANT, that is, the path connected to the right side of the fourth switch 30 in FIG. 1) are not integrated together by a circuit, such as a switch circuit in a subsequent stage. To put it another way, if the path connected to the selection terminal 22 and the path connected to the selection terminal 32 are integrated together by a switch that selects one of multiple inputs and outputting the selected input in a subsequent stage, the first signal path 200 and the second signal path 300 are not different paths. If the path connected to the selection terminal 22 and the path connected to the selection terminal 32 are each connected to a common ground or connected to different terminals of one RF signal processing circuit, the first signal path 200 and the second signal path 300 are different paths.

By using the diversity switch circuit 1 that is able to receive multiple signals of different frequency bands and simultaneously send multiple sending signals of different frequency bands, the diversity antenna ANT is able to be used as a transmit-and-receive antenna.

### Second Preferred Embodiment

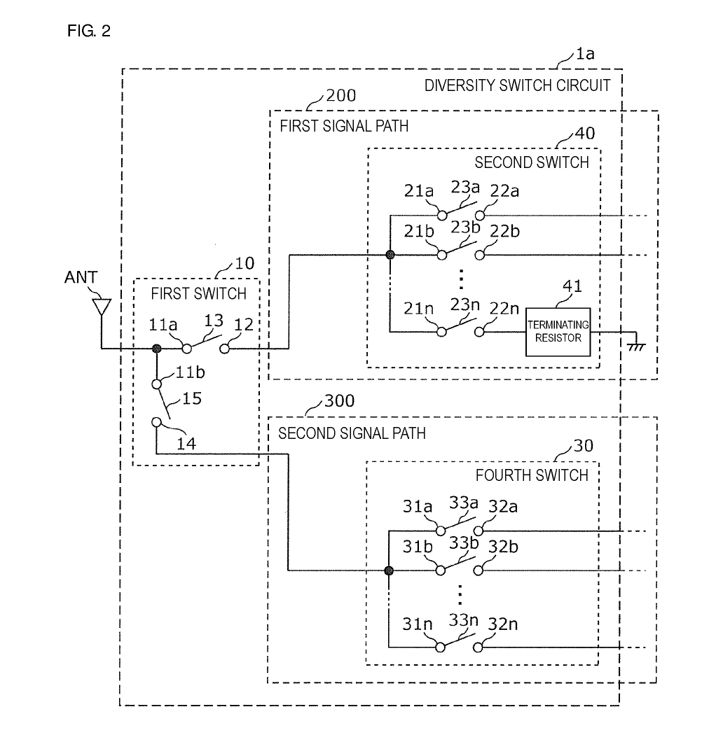

A diversity switch circuit 1a according to a second preferred embodiment of the present invention will be described below with reference to FIG. 2.

FIG. 2 is a schematic diagram illustrating an example of the diversity switch circuit 1a according to the second preferred embodiment.

The diversity switch circuit 1a according to the second preferred embodiment is different from the diversity switch circuit 1 according to the first preferred embodiment in that it includes a second switch 40 instead of the second switch 20. The configurations of the other components are similar to those of the first preferred embodiment, and an explanation thereof will thus be omitted. The second switch 40 is different from the second switch 20 in that it includes a terminating resistor 41. The configurations of the other components of the second switch 40 are similar to those of the first preferred embodiment, and an explanation thereof will thus be omitted.

The terminating resistor 41 is connected to one of at least two selection terminals 22 of the second switch 40. One end of the terminating resistor 41 is connected to the second selection terminal 22, while the other end thereof is grounded. The terminating resistor 41 outputs energy of a signal input into the second switch 40 to a ground, and the resistance of the terminating resistor 41 is about 50Ω, for example. The terminating resistor 41 may be built in the second switch 40. In the second preferred embodiment, the terminating resistor 41 is connected to the selection terminal 22n, as shown in FIG. 2.

The diversity antenna ANT is used as a transmit-and-receive antenna. For this reason, even when the first common terminal 11 and the first selection terminal 12 are not connected to each other, a high-power sending signal transmitted to the second signal path 300 may leak to the second switch 40. Additionally, even when the first common terminal 11 and the first selection terminal 12 are not connected to each other, a high power signal received by the diversity antenna ANT may leak to the second switch 40. A circuit, such as a filter that filters a received signal or an LNA that amplifies a received signal, is connected to the second switch 40. When receiving a high power signal, such a circuit may be broken or the performance may be decreased. To address this issue, the terminating resistor 41 is connected to one of the at least two selection terminals 22 of the second switch 40. When the diversity antenna ANT is used as a transmit antenna or when the diversity antenna ANT receives a high power signal, by connecting the second common terminal 21 and the selection terminal to which the terminating resistor 41 is connected, the terminating resistor 41 is able to output energy of a high power signal to a ground. It is thus less likely that a circuit, such as a filter or an LNA, connected to the second switch 40 will be broken or the performance will be decreased.

### Third Preferred Embodiment

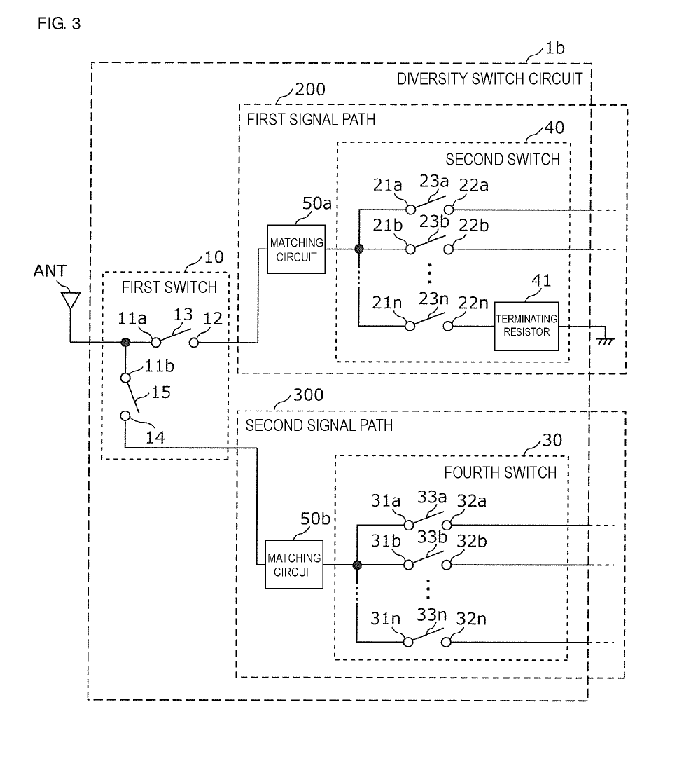

A diversity switch circuit 1b according to a third preferred embodiment of the present invention will be described below with reference to FIG. 3.

FIG. 3 is a schematic diagram illustrating an example of the diversity switch circuit 1b according to the third preferred embodiment.

The diversity switch circuit 1b according to the third preferred embodiment is different from the diversity switch circuit 1a according to the second preferred embodiment in that it includes a matching circuit 50. The configurations of the other components are similar to those of the second preferred embodiment, and an explanation thereof will thus be omitted. In the third preferred embodiment, the diversity switch circuit 1b includes matching circuits 50a and 50b, which are collectively called the matching circuit 50.

The matching circuit 50a is connected between the first selection terminal 12 and the second common terminal 21. The matching circuit 50b is connected between the second selection terminal 14 and the third common terminal 31. The matching circuit 50 is an impedance matching circuit including elements, such as capacitors or inductors. The matching circuit 50 is able to perform impedance matching between the first switch 10 and the second switch 40 and between the first switch 10 and the fourth switch 30, thus decreasing the level of loss (return loss) which may occur in a signal transmitted to the first and second signal paths 200 and 300.

As described above, filters having different pass bands from each other are connected to the at least two selection terminals 22 of the second switch 40. That is, the frequency band for which the matching circuit 50a performs impedance matching differs depending on which switch 23 will be turned ON. The matching circuit 50a predicts which switch 23 in the second switch 40 will be turned ON and adjusts itself in advance to the frequency band of a signal to be subjected to impedance matching. If the parameter used to perform impedance matching in the matching circuit 50a is variable, a control signal for turning ON or OFF the switch 23 received by the second switch 40 is also received by the matching circuit 50a. That is, the matching circuit 50a is able to identify the switch 23 to be turned ON in the second switch 40, that is, the matching circuit 50a is able to identify the frequency band to be subjected to impedance matching. The matching circuit 50a includes plural circuits having different parameters, such as the value of an inductor or a capacitor, or having different connection modes. In each of these circuits, the parameter, such as the value of an inductor or a capacitor, or the connection mode has been adjusted so that impedance matching is able to be performed according to the associated frequency band. The matching circuit 50a includes a switch that is able to select one of these circuits to be connected between the first switch 10 and the second switch 40 in accordance with a control signal received by the matching circuit 50a. This configuration enables the matching circuit 50a to perform impedance matching for the frequency band associated with the switch 23 to be turned ON in the second switch 40.

Similarly, filters having different pass bands from each other are connected to the at least two selection terminals 32 of the fourth switch 30. That is, the frequency band for which the matching circuit 50b performs impedance matching differs depending on which switch 33 will be turned ON. The matching circuit 50b predicts which switch 33 in the fourth switch 30 will be turned ON and adjusts itself in advance to the frequency band of a signal to be subjected to impedance matching. If the parameter used to perform impedance matching in the matching circuit 50b is variable, a control signal to turn ON or OFF the switch 33 received by the fourth switch 30 is also received by the matching circuit 50b. That is, the matching circuit 50b is able to identify the switch 33 to be turned ON in the fourth switch 30, that is, the matching circuit 50b is able to identify the frequency band to be subjected to impedance matching. The matching circuit 50b includes plural circuits having different parameters, such as the value of an inductor or a capacitor, or having different connection modes. In each of these circuits, the parameter, such as the value of an inductor or a capacitor, or the connection mode has been adjusted so that impedance matching is able to be performed according to the associated frequency band. The matching circuit 50b includes a switch that is able to select one of these circuits to be connected between the first switch 10 and the fourth switch 30 in accordance with a control signal received by the matching circuit 50b. This configuration enables the matching circuit 50b to perform impedance matching for the frequency band associated with the switch 33 to be turned ON in the fourth switch 30.

As described above, the impedance matching parameter or the connection mode of the matching circuit 50 is adjusted in advance to the frequency band to be subjected to impedance matching, or is changed in accordance with a control signal for turning ON or OFF the switch 23 received by the second switch 40 or the switch received by the fourth switch 30. It is thus possible to achieve significantly improved or optimal impedance matching according to the frequency band.

### Fourth Preferred Embodiment

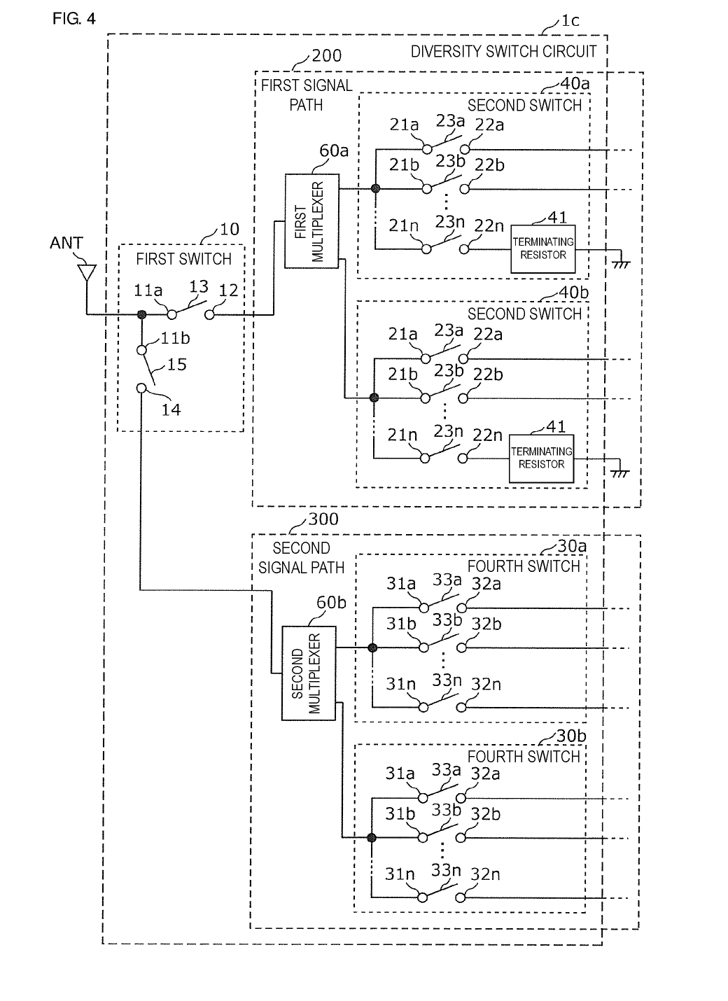

A diversity switch circuit 1c according to a fourth preferred embodiment of the present invention will be described below with reference to FIG. 4.

FIG. 4 is a schematic diagram illustrating an example of the diversity switch circuit 1c according to the fourth preferred embodiment.

The diversity switch circuit 1c according to the fourth preferred embodiment is different from the diversity switch circuit 1a according to the second preferred embodiment in that the diversity switch circuit 1c includes a multiplexer 60, the second switch 40 includes two or more second switches 40, and the fourth switch 30 includes two or more fourth switches 30. The configurations of the other components are similar to those of the second preferred embodiment, and an explanation thereof will thus be omitted. In the fourth preferred embodiment, the diversity switch circuit 1c includes first and second multiplexers 60a and 60b, which are collectively called the multiplexer 60. The diversity switch circuit 1c includes second switches 40a and 40b, which are collectively called the second switch 40. The diversity switch circuit 1c includes fourth switches 30a and 30b, which are collectively called the fourth switch 30.

The first multiplexer 60a is connected between the first selection terminal 12 and the second common terminal 21 of each of the two or more second switches 40. The second multiplexer 60b is connected between the second selection terminal 14 and the third common terminal 31 of each of the two or more fourth switches 30. The multiplexer 60 is a filter which is used in frequency division duplexing (FDD) communication, for example, and separates one signal into multiple signals of different frequency bands or integrates multiple signals of different frequency bands into one signal. Although the multiplexer 60 is a duplexer in the fourth preferred embodiment, it may be a triplexer or a quadplexer, for example.

The first multiplexer 60a enables the diversity switch circuit 1c to simultaneously receive multiple signals of different frequency bands, such as a low band (LB), a middle band (MB), and a high band (HB), received by the diversity antenna ANT. The diversity switch circuit 1c can thus perform CA communication. The LB is about 700 MHz to about 900 MHz, for example. The MB is about 1800 MHz to about 2200 MHz, for example. The HB is about 2300 MHz to about 2700 MHz, for example. The second multiplexer 60b enables the diversity switch circuit 1c to simultaneously send multiple signals of different frequency bands, such as the LB, MB, and HB. The diversity switch circuit 1c is thus able to perform CA communication.

The multiplexer 60 may include filters constituted by elastic wave resonators, LC circuits, or both of them. The elastic wave resonator may be a surface acoustic wave (SAW) resonator or a bulk acoustic wave (BAW) resonator. The SAW resonator includes a substrate and interdigital transducer (IDT) electrodes. The substrate is a substrate having piezoelectricity at least on its surface. For example, the substrate may include a piezoelectric thin film on its surface, and may be a multilayer body including the piezoelectric thin film and another film having different acoustic velocities, and a support substrate. Alternatively, the entirety of the substrate may have piezoelectricity. In this case, the substrate is a piezoelectric substrate defined by a single piezoelectric layer.

The filters of the multiplexer 60 may be band pass filters. Other examples of the filters are a high pass filter, a low pass filter, and a band elimination filter.

### Fifth Preferred Embodiment

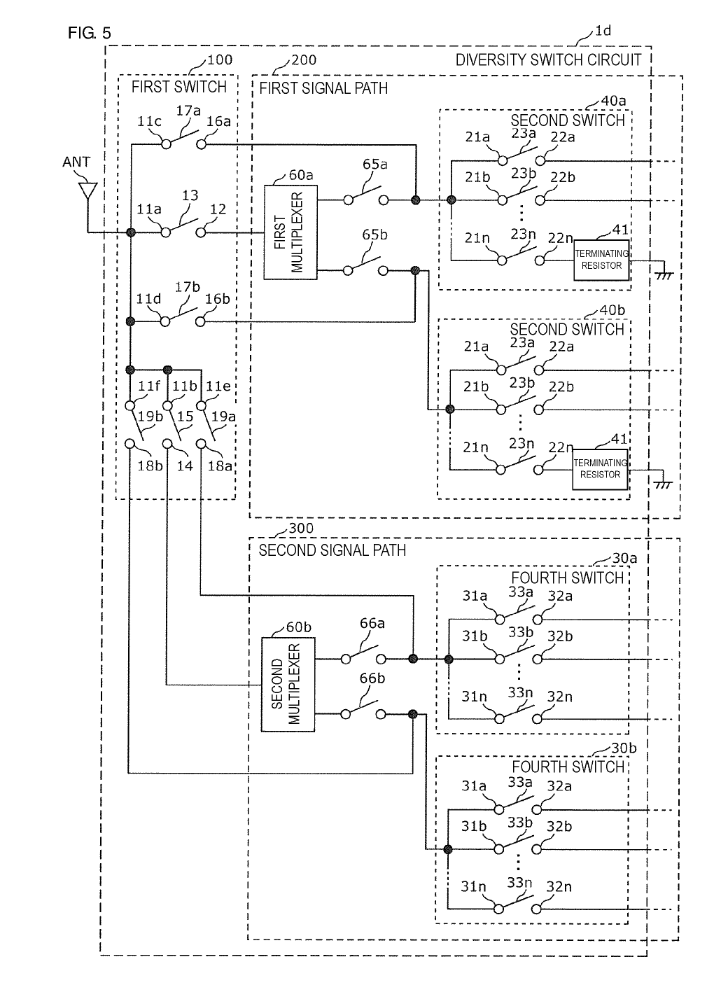

A diversity switch circuit 1d according to a fifth preferred embodiment of the present invention will be described below with reference to FIG. 5.

FIG. 5 is a schematic diagram illustrating an example of the diversity switch circuit 1d according to the fifth preferred embodiment.

The diversity switch circuit 1d according to the fifth preferred embodiment is different from the diversity switch circuit 1c according to the fourth preferred embodiment in that it includes a first switch 100 instead of the first switch 10 and also includes a third switch 65 between the first multiplexer 60a and the second switch 40 and a fifth switch 66 between the second multiplexer 60b and the fourth switch 30. The first switch 100 and the first signal path 200 are connected to each other via multiple paths. The first switch 100 and the second signal path 300 are also connected to each other via multiple paths. The configurations of the other components are similar to those of the fourth preferred embodiment, and an explanation thereof will thus be omitted.

The first switch 100 includes a first common terminal 11 connected to the diversity antenna ANT, a first selection terminal 12 and a third selection terminal 16 connected to the first signal path 200, and a second selection terminal 14 and a fourth selection terminal 18 connected to the second signal path 300. A path connecting the third selection terminal 16 and the first signal path 200 is called a first bypass path. A path connecting the fourth selection terminal 18 and the second signal path 300 is called a second bypass path. The first switch 100 includes switches 13, 15, 17, and 19. In the fifth preferred embodiment, the first switch 100 includes first common terminals 11a through 11f, which are collectively called the first common terminal 11. The first switch 100 also includes third selection terminals 16a and 16b, which are collectively called the third selection terminal 16, and fourth selection terminals 18a and 18b, which are collectively called the fourth selection terminal 18. The first switch 100 also includes switches 17a and 17b, which are collectively called the switch 17, and switches 19a and 19b, which are collectively called the switch 19.

A third switch 65a is connected between the first multiplexer 60a and each second common terminal 21 of the second switch 40a. More specifically, as shown in FIG. 5, the diversity switch circuit 1d includes the third switch 65a at a position closer to the first multiplexer 60a than to a node between a path connected to the third selection terminal 16a and a path connecting the first multiplexer 60a and the second switch 40a, as viewed from this node. Similarly, the diversity switch circuit 1d includes a third switch 65b between the first multiplexer 60a and the second switch 40b.

A fifth switch 66a is connected between the second multiplexer 60b and each third common terminal 31 of the fourth switch 30a. More specifically, as shown in FIG. 5, the diversity switch circuit 1d includes the fifth switch 66a at a position closer to the second multiplexer 60b than to a node between a path connected to the fourth selection terminal 18a and a path connecting the second multiplexer 60b and the fourth switch 30a, as viewed from this node. Similarly, the diversity switch circuit 1d includes a fifth switch 66b between the second multiplexer 60b and the fourth switch 30b. In the fifth preferred embodiment, the third switches 65a and 65b are collectively called the third switch 65, and the fifth switches 66a and 66b are collectively called the fifth switch 66.

By turning ON the switch 13 and the third switches 65a and 65b, a signal received by the diversity antenna ANT is transmitted to the first signal path 200 via the first multiplexer 60a. By turning ON the switch 15 and the fifth switches 66a and 66b, a signal transmitted to the second signal path 300 is sent to the diversity antenna ANT via the second multiplexer 60b. When the first common terminal 11c and the third selection terminal 16a are connected to each other by turning ON the switch 17a and when the third switch 65a is OFF, a signal received by the diversity antenna ANT is transmitted to the first signal path 200 without passing through the first multiplexer 60a. When the first common terminal 11d and the third selection terminal 16b are connected to each other by turning ON the switch 17b and when the third switch 65b is OFF, a signal received by the diversity antenna ANT is transmitted to the first signal path 200 without passing through the first multiplexer 60a. When the first common terminal 11e and the fourth selection terminal 18a are connected to each other by turning ON the switch 19a and when the fifth switch 66a is OFF, a signal transmitted to the second signal path 300 is sent to the diversity antenna ANT without passing through the second multiplexer 60b. When the first common terminal 11f and the fourth selection terminal 18b are connected to each other by turning ON the switch 19b and when the fifth switch 66b is OFF, a signal transmitted to the second signal path 300 is sent to the diversity antenna ANT without passing through the second multiplexer 60b.

When the switch 13 is ON, the switches 15, 17a, 17b, 19a, and 19b are OFF. When at least one of the switches 17a and 17b is ON, the switches 13, 15, 19a, and 19b are OFF. When the switch 15 is ON, the switches 13, 17a, 17b, 19a, and 19b are OFF. When at least one of the switches 19a and 19b is ON, the switches 13, 15, 17a, and 17b are OFF. When one of the switches 13, 17a, and 17b is ON, one of the switches 15, 19a, and 19b may be ON. Similarly, when one of the switches 15, 19a, and 19b is ON, one of the switches 13, 17a, and 17b may be ON.

The switches 17 and 19 are semiconductor switches such as diode switches or FET switches, and are turned ON or OFF in accordance with a control signal from an external source (RF signal processing circuit 120, which will be discussed later, for example) outside the first switch 100. Similarly, the third and fifth switches 65 and 66 are semiconductor switches such as diode switches or FET switches, and are turned ON or OFF in accordance with a control signal from an external source (RF signal processing circuit 120, which will be discussed later, for example) outside the diversity switch circuit 1d. The first common terminals 11a through 11f may be one integrated terminal. In this case, instead of the switches 13, 15, 17, and 19, the first switch 100 includes a switch that changes the connection between the integrated first common terminal 11 and one of the first selection terminal 12, the second selection terminal 14, the third selection terminal 16, and the fourth selection terminal 18. However, the first common terminal 11 may still be able to simultaneously connect to one of the first and third selection terminals 12 and 16 and to one of the second and fourth selection terminals 14 and 18.

By using the multiplexer 60, CA communication is able to be performed. However, when a signal passes through the multiplexer 60, loss occurs because of the multiplexer 60. For example, in the diversity switch circuit 1c shown in FIG. 4, all signals sent and received by the diversity antenna ANT pass through the multiplexer 60. However, CA communication may not be necessary, depending on the purpose or the situation of use of a communication device on which the diversity antenna circuit 1c is mounted. Even in this case, a signal passes through the multiplexer 60, which causes loss in the signal.

To address this issue, in the fifth preferred embodiment, when the first common terminal 11 and the third selection terminal 16 are connected to each other and when the third switch 65 is OFF, a signal received by the diversity antenna ANT passes through the first bypass path without passing through the first multiplexer 60a and is transmitted to the first signal path 200. As a result, when CA communication is not performed, loss which may occur in a received signal is able to be reduced. When the first common terminal 11 and the fourth selection terminal 18 are connected to each other and when the fifth switch 66 is OFF, a signal transmitted to the second signal path 300 passes through the second bypass path without passing through the second multiplexer 60b and is sent to the diversity antenna ANT. As a result, when CA communication is not performed, loss which may occur in a sending signal is able to be reduced.

### Sixth Preferred Embodiment

A diversity switch circuit according to a preferred embodiment of the present invention is applicable to a radio-frequency module and a communication device. In a sixth preferred embodiment of the present invention, a radio-frequency module 110 including the diversity switch circuit 1 and a communication device 130 including the radio-frequency module 110 will be described.

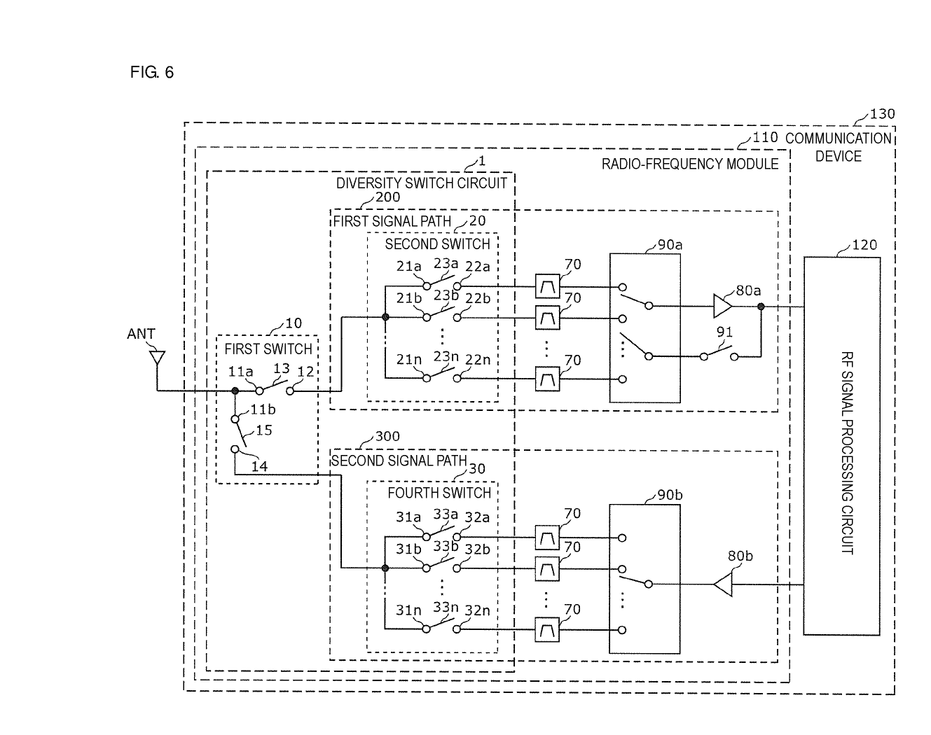

FIG. 6 is a schematic diagram illustrating an example of the communication device 130 according to the sixth preferred embodiment.

The communication device 130 includes the radio-frequency module 110 and an RF signal processing circuit (RFIC) 120.

The radio-frequency module 110 sends signals to be sent from the diversity antenna ANT and receives signals received by the diversity antenna ANT between the diversity antenna ANT and the RF signal processing circuit 120. The radio-frequency module 110 includes the diversity switch circuit 1, plural filters 70 connected to the at least two selection terminals 22 of the second switch 20 and to the at least two selection terminals 32 of the fourth switch 30, and an amplifier circuit 80 connected to the plural filters 70. The radio-frequency module 110 also includes a sixth switch 90. The amplifier circuit 80 is connected to the filters 70 via the sixth switch 90. The radio-frequency module 110 also includes a switch 91 connected to a terminal of the sixth switch 90 on the side closer to the RF signal processing circuit 120. The diversity switch circuit 1 is similar to that of the first preferred embodiment, and an explanation thereof will thus be omitted.

In the sixth preferred embodiment, the radio-frequency module 110 includes an LNA 80a and a PA 80b, which are collectively called the amplifier circuit 80. The radio-frequency module 110 includes six switches 90a and 90b, which are collectively called the sixth switch 90. As discussed above, the radio-frequency module 110 includes the switch 91.

The filters 70 are filters including elastic wave resonators, LC circuits, or both of them. The elastic wave resonators may be SAW resonators or BAW resonators. The SAW resonator includes a substrate and IDT electrodes. The substrate is a substrate having piezoelectricity at least on its surface. For example, the substrate may include a piezoelectric thin film on its surface, and may be a multilayer body including the piezoelectric thin film and another film having different acoustic velocities, and a support substrate. Alternatively, the entirety of the substrate may have piezoelectricity. In this case, the substrate is a piezoelectric substrate defined by a single piezoelectric layer.

The filters 70 may be band pass filters. Other examples of the filters 70 are a high pass filter, a low pass filter, and a band elimination filter. The filters 70 have different pass bands from each other. The filters 70 are connected to the selection terminal 22, so that the diversity switch circuit 1 is able to receive signals of different frequency bands. The pass bands of the filters 70 are in a range of about 700 MHz to about 3.5 GHz, for example. The filters 70 are connected to the selection terminal 32, so that one or more sending signals selected by the fourth switch 30 among multiple sending signals of different frequency bands can be sent from the diversity antenna ANT.

The sixth switch 90 have plural selection terminals connected to the filters 70, a common terminal connected to the amplifier circuit 80, and a common terminal connected to the switch 91. The sixth switch 90 selects one of the common terminals and one of the selection terminals in accordance with a control signal output from the RF signal processing circuit 120, for example. For example, the sixth switch 90 selects the selection terminal connected to the filter 70 associated with a desired frequency band and the common terminal connected to the amplifier circuit 80 or the switch 91.

The LNA 80a is a receiving amplifier circuit which amplifies a received signal and outputs it to the RF signal processing circuit 120. The PA 80b is a sending amplifier circuit which amplifies a sending signal and outputs it to the sixth switch 90b.

The switch 91 is turned ON when amplifying of a received signal is not necessary. When the switch 91 is ON, the selection terminal connected to the filter 70 is connected to the common terminal connected to the switch 91 instead of that connected to the LNA 80a.

The RF signal processing circuit 120 is a circuit that processes a sending signal to be sent from the diversity antenna ANT and a signal received by the diversity antenna ANT. The RF signal processing circuit 120 performs signal processing, such as down-conversion, on a received signal input from the diversity antenna ANT via the first signal path 200 and outputs the resulting received signal to a baseband signal processing circuit (not shown). The RF signal processing circuit 120 performs signal processing, such as up-conversion, on a sending signal input from the baseband signal processing circuit (not shown) and outputs the resulting sending signal to the diversity antenna ANT via the second signal path 300.

As described above, the diversity switch circuit according to a preferred embodiment of the present invention may be applied to the radio-frequency module 110 and the communication device 130.

### Other Preferred Embodiments

The diversity switch circuits, the radio-frequency module, and the communication device according to preferred embodiments of the present invention have been discussed. However, the present invention is not restricted to the above-described preferred embodiments.

Although in the above-described preferred embodiments the diversity switch circuit includes the fourth switch 30, it may not necessarily include the fourth switch 30.

In the second through fifth preferred embodiments, the terminating resistor 41 is built in the second switch 40 and is connected to the selection terminal 22. However, the terminating resistor 41 may be disposed outside the second switch 40 and be connected to the selection terminal 22.

In the second through fifth preferred embodiments, the diversity switch circuit includes the second switch 40 including the terminating resistor 41. However, the diversity switch circuit may include the second switch 20 without a terminating resistor 41, such as that of the first preferred embodiment.

In the third preferred embodiment, the matching circuit 50 is connected between the first selection terminal 12 and the second common terminal 21 and between the second selection terminal 14 and the third common terminal 31. Alternatively, the matching circuit 50 may be connected only one of between the first selection terminal 12 and the second common terminal 21 and between the second selection terminal 14 and the third common terminal 31.

In the fourth and fifth preferred embodiments, a matching circuit 50 is connected neither between the first selection terminal 12 and the second common terminal 21 nor between the second selection terminal 14 and the third common terminal 31. However, a matching circuit 50 may be connected at least one of between the first selection terminal 12 and the second common terminal 21 and between the second selection terminal 14 and the third common terminal 31. The multiplexer 60 may have the function of the matching circuit 50. In other words, the multiplexer 60 and the matching circuit 50 may be provided integrally.

In the fifth preferred embodiment, a matching circuit 50 is connected neither between the third selection terminal 16 and the second common terminal 21 nor between the fourth selection terminal 18 and the third common terminal 31. However, a matching circuit 50 may be connected at least one of between the third selection terminal 16 and the second common terminal 21 and between the fourth selection terminal 18 and the third common terminal 31.

Although in the fourth and fifth preferred embodiments the diversity switch circuits 1c and 1d each include two second switches 40 and two fourth switches 30, they may include three or more second switches and three or more fourth switches.

Although in the sixth preferred embodiment the radio-frequency module 110 includes the diversity switch circuit 1, it may alternatively include one of the diversity switch circuits 1a through 1d.

Preferred embodiments obtained by making various modifications to the above-described preferred embodiments by those skilled in the art and preferred embodiments achieved by combining the elements and functions of the above-described preferred embodiments without departing from the scope and spirit of the invention are also encompassed in the present invention.

Preferred embodiments of the present invention are widely applicable to communication devices, such as cellular phones, as diversity switch circuits, radio-frequency modules, and communication devices that are able to use a diversity antenna as a transmit-and-receive antenna.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A diversity switch circuit comprising:
a first switch including a first common terminal connected to a diversity antenna, a first selection terminal connected to a first signal path, and a second selection terminal connected to a second signal path, the second signal path being a path different from the first signal path; and
a second switch that is disposed in the first signal path and that includes a second common terminal connected to the first selection terminal and includes at least two selection terminals; wherein
a received signal received by the diversity antenna is transmitted to the first signal path when the first common terminal and the first selection terminal are connected to each other; and
a sending signal to be sent by the diversity antenna is transmitted to the second signal path when the first common terminal and the second selection terminal are connected to each other.

2. The diversity switch circuit according to claim 1, wherein a terminating resistor is connected to one of the at least two selection terminals of the second switch.

3. The diversity switch circuit according to claim 1, wherein a matching circuit is connected between the first selection terminal and the second common terminal.

4. The diversity switch circuit according to claim 1, wherein
the second switch includes two or more second switches; and
a first multiplexer is connected between the first selection terminal and the second common terminal of each of the two or more second switches.

5. The diversity switch circuit according to claim 4, wherein
the first switch includes a third selection terminal connected to the first signal path;
a third switch is connected between the first multiplexer and the second common terminal; and
a received signal received by the diversity antenna is transmitted to the first signal path without passing through the first multiplexer when the first common terminal and the third selection terminal are connected to each other and when the third switch is OFF.

6. The diversity switch circuit according to claim 1, further comprising:
a fourth switch that is disposed in the second signal path and includes a third common terminal connected to the second selection terminal and includes at least two selection terminals.

7. The diversity switch circuit according to claim 6, wherein a matching circuit is connected between the second selection terminal and the third common terminal.

8. The diversity switch circuit according to claim 6, wherein
the fourth switch includes two or more fourth switches; and
a second multiplexer is connected between the second selection terminal and the third common terminal of each of the two or more fourth switches.

9. The diversity switch circuit according to claim 8, wherein
the first switch also includes a fourth selection terminal connected to the second signal path;
a fifth switch is connected between the second multiplexer and the third common terminal; and
a sending signal to be sent by the diversity antenna is transmitted to the second signal path without passing through the second multiplexer when the first common terminal and the fourth selection terminal are connected to each other and when the fifth switch is OFF.

10. A radio-frequency module comprising:
the diversity switch circuit according to claim 1;
a filter connected to the at least two selection terminals of the second switch; and
an amplifier circuit connected to the filter.

11. The radio-frequency module according to claim 10, wherein a terminating resistor is connected to one of the at least two selection terminals of the second switch.

12. The radio-frequency module according to claim 10, wherein a matching circuit is connected between the first selection terminal and the second common terminal.

13. The radio-frequency module according to claim 10, wherein
the second switch includes two or more second switches; and
a first multiplexer is connected between the first selection terminal and the second common terminal of each of the two or more second switches.

14. The radio-frequency module according to claim 13, wherein
the first switch includes a third selection terminal connected to the first signal path;
a third switch is connected between the first multiplexer and the second common terminal; and
a received signal received by the diversity antenna is transmitted to the first signal path without passing through the first multiplexer when the first common terminal and the third selection terminal are connected to each other and when the third switch is OFF.

15. The radio-frequency module according to claim 10, further comprising:
a fourth switch that is disposed in the second signal path and includes a third common terminal connected to the second selection terminal and includes at least two selection terminals.

16. The radio-frequency module according to claim 15, wherein a matching circuit is connected between the second selection terminal and the third common terminal.

17. The radio-frequency module according to claim 15, wherein
the fourth switch includes two or more fourth switches; and
a second multiplexer is connected between the second selection terminal and the third common terminal of each of the two or more fourth switches.

18. The radio-frequency module according to claim 17, wherein
the first switch also includes a fourth selection terminal connected to the second signal path;
a fifth switch is connected between the second multiplexer and the third common terminal; and
a sending signal to be sent by the diversity antenna is transmitted to the second signal path without passing through the second multiplexer when the first common terminal and the fourth selection terminal are connected to each other and when the fifth switch is OFF.

19. A communication device comprising:
a radio-frequency signal processing circuit that processes the received signal and the sending signal; and
the radio-frequency module according to claim 10 that sends the sending signal and receives the received signal between the diversity antenna and the radio-frequency signal processing circuit.
